(19) United States
(12) Patent Application Publication
(10) Pub. No.: US 2025/0095156 A1
(43) Pub. Date: Mar. 20, 2025

(54) Semantic Segmentation Rendering For Precise Localization Of Structure Components On Captured Images

(71) Applicant: Skydio, Inc., San Mateo, CA (US)

(72) Inventors: Adam Parker Bry, Redwood City, CA (US); Hayk Martirosyan, San Francisco, CA (US); Vincent Lecrubier, Lisbon (PT)

(21) Appl. No.: 18/892,298

(22) Filed: Sep. 20, 2024

Related U.S. Application Data
(60) Provisional application No. 63/539,354, filed on Sep. 20, 2023.

(51) Int. Cl. G06T 7/12; G06T 9/00; G06T 15/06; G06T 15/80; G06V 10/762; G06V 20/17

(52) U.S. Cl. CPC G06T 7/12; G06T 9/00; G06T 15/06; G06T 15/80; G06V 10/7635; G06V 20/17

(57) ABSTRACT

Semantic segmentation rendering is performed to encode structural data, including precise and relative component locations, in pixel values of an image depicting a structure. Images captured during a UAV-based exploration inspection of a structure are obtained. In each pixel value that corresponds to the structure within the images, identifiers of the structure, a component of the structure depicted using the pixel value, and a location of the component are encoded. The pixel values of the images are segmented into polygons according to the encoded identifiers, and data indicative of the polygons is stored for use in a further inspection of the structure. In connection with the semantic segmentation rendering, a three-dimensional graphical representation of the structure is obtained and rendered, according to the encoded identifiers, using shaders that visually distinguish each component of the structure, in which the data indicative of the polygons identifies respective ones of the shaders.

### CROSS-REFERENCE TO RELATED APPLICATION(S)

This application claims the benefit of U.S. Provisional Application Ser. No. 63/539,354, filed Sep. 20, 2023, the entire disclosure of which is herein incorporated by reference.

### TECHNICAL FIELD

This application generally relates to structure inspection using an unmanned aerial vehicle (UAV), and, more specifically, to semantic segmentation rendering for the precise localization of structure components on images captured during a structure inspection.

### BACKGROUND

UAVs are often used to capture images from vantage points that would otherwise be difficult for humans to reach. Typically, a UAV is operated by a human using a controller to remotely control the movements and image capture functions of the UAV. In some cases, a UAV may have automated flight and autonomous control features. For example, automated flight features may rely upon various sensor input to guide the movements of the UAV.

### SUMMARY

Systems and techniques for, inter alia, semantic segmentation rendering for precise localization of structure components on captured images are disclosed.

In some implementations, a method comprises: obtaining images captured during an unmanned aerial vehicle-based exploration inspection of a structure; encoding, in each pixel value that corresponds to the structure within the images, identifiers of the structure, a component of the structure depicted using the pixel value, and a location of the component; segmenting pixel values of the images into polygons according to the encoded identifiers; and storing data indicative of the polygons for use in a further inspection of the structure.

In some implementations of the method, the method comprises: obtaining a three-dimensional graphical representation of the structure; and rendering, according to the encoded identifiers, the three-dimensional graphical representation of the structure using shaders that visually distinguish each component of the structure, wherein the data indicative of the polygons identifies respective ones of the shaders.

In some implementations of the method, obtaining the three-dimensional graphical representation of the one or more structures comprises: generating the three-dimensional graphical representation based on the images using a ray-based optimization technique.

In some implementations of the method, rendering the three-dimensional graphical representation of the structure using the shaders for each component of the structure according to the encoded identifiers comprises: generating a UV map of the structure according to the shaders; and rendering the three-dimensional graphical representation of the structure based on the UV map.

In some implementations of the method, each pixel value is represented by coordinates of the UV map.

In some implementations of the method, rendering the three-dimensional graphical representation of the structure using the shaders for each component of the structure according to the encoded identifiers comprises: rendering different surfaces of a component of the structure within the three-dimensional graphical representation using different ones of the shaders.

In some implementations of the method, segmenting the pixel values of the images into the polygons according to the encoded identifiers comprises: performing a panoptic segmentation process against the images to segment the pixel values into vector annotations corresponding to the polygons.

In some implementations of the method, the method comprises: for each component of the structure, determining a location of the component using a visual positioning system of the unmanned aerial vehicle and pose information of the unmanned aerial vehicle.

In some implementations of the method, the method comprises: obtaining a query for images depicting the structure of one or more structures; and using the stored data to indicate the images in response to the query.

In some implementations, a UAV comprises: one or more cameras; one or more memories; and one or more processors configured to execute instructions stored in the one or more memories to: capture images of a structure using the one or more cameras; render a three-dimensional graphical representation of the structure with shaders visually distinguishing components of the structure by encoding, in each pixel value that corresponds to the structure within the images, identifiers of the structure, a component of the structure depicted using the pixel value, and a location of the component; and storing data indicative of polygons associated with pixel values of the images for use in a further inspection of the structure.

In some implementations of the UAV, the one or more processors are configured to execute the instructions to: segment the pixel values of the images into the polygons according to the encoded identifiers.

In some implementations of the UAV, to segment the pixel values of the images into the polygons according to the encoded identifiers, the one or more processors are configured to execute the instructions to: perform a panoptic segmentation process against the images to segment the pixel values into vector annotations corresponding to the polygons.

In some implementations of the UAV, to render the three-dimensional graphical representation of the structure with the shaders, the one or more processors are configured to execute the instructions to: generate a UV map of the structure according to the shaders; and render the three-dimensional graphical representation of the structure based on the UV map.

In some implementations of the UAV, to render the three-dimensional graphical representation of the structure with the shaders, the one or more processors are configured to execute the instructions to: associate the pixel value with coordinates of the UV map of the structure.

In some implementations, a system comprises: an unmanned aerial vehicle; and a user device in communication with the unmanned aerial vehicle, wherein the unmanned aerial vehicle is configured to: render a three-dimensional graphical representation of a structure with shaders visually distinguishing components of the structure by encoding, in each pixel value that corresponds to the structure within images captured of the structure, identifiers of the structure, a component of the structure depicted using the pixel value, and a location of the component; and cause an output of data associated with the rendered three-dimensional graphical representation of the structure at the user device.

In some implementations of the system, the unmanned aerial vehicle is configured to: capture the images; and obtain the three-dimensional graphical representation of the structure.

In some implementations of the system, to obtain the three-dimensional graphical representation of the structure, the unmanned aerial vehicle is configured to: generate the three-dimensional graphical representation based on the images using graph clustering.

In some implementations of the system, the unmanned aerial vehicle is configured to: segment pixel values of the images into polygons according to the encoded identifiers; and store data indicative of the polygons for use in a further inspection of the structure.

In some implementations of the system, to segment the pixel values of the images into the polygons according to the encoded identifiers, the unmanned aerial vehicle is configured to: perform a panoptic segmentation process against the images to segment the pixel values into vector annotations corresponding to the polygons.

In some implementations of the system, the data indicative of the polygons identifies respective ones of the shaders.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an illustration of an example of a UAV system.

FIG. 2A is an illustration of an example of a UAV as seen from above.

FIG. 2B is an illustration of an example of a UAV as seen from below.

FIG. 3 is an illustration of an example of a controller for a UAV.

FIG. 4 is an illustration of an example of a dock for facilitating autonomous landing of a UAV.

FIG. 5 is a block diagram of an example of a hardware configuration of a UAV.

FIG. 6 is a block diagram of an example of a semantic segmentation rendering system.

FIG. 7 is a block diagram of example functionality of semantic segmentation rendering software.

FIG. 8 is an illustration of an example of a structure and its components for which semantic output may be generated.

FIG. 9 is an illustration of an example of a UV map for a structure and encodings for a pixel value corresponding to a portion of the structure.

FIG. 10 is a flowchart of an example of a technique for semantic segmentation rendering for precise localization of structure components on captured images.

### DETAILED DESCRIPTION

The versatility of UAVs has made their use in structural inspection increasingly common in recent years. Personnel of various industries operate UAVs to navigate about structures (e.g., buildings, towers, bridges, pipelines, and utility equipment) and capture visual media indicative of the statuses and conditions thereof. Initially, UAV inspection processes involved the manual-only operation of a UAV, such as via a user device wirelessly communicating with the UAV; however, automated approaches have been more recently used in which a UAV determines a target structure and performs a sophisticated navigation and media capture process to automatically fly around the structure and capture images and/or video thereof. In some such cases, these automated approaches may involve the UAV or a computing device in communication therewith performing a 3D scan of a target structure to generate a high-fidelity 3D geometric reconstruction thereof as part of an inspection process. For example, modeling of the 3D geometric reconstruction may be provided to a UAV operator to enable the UAV operator to identify opportunities for a further inspection of the structure.

However, these 3D scan approaches, although representing meaningful improvements over more manual and semi-manual inspection processes, may not be suitable in all structure inspection situations. In particular, such approaches generally involve high-fidelity processing and thus use large amounts of input media generate the 3D geometric reconstruction. This ultimately involves the capture of large amounts of images or videos over a relatively long period of time. Moreover, the 3D geometric reconstruction is purely geometric in that the reconstruction resulting from the 3D scan approach is limited to geometries of the structure. In some situations, however, a UAV operator may not need high-fidelity data about all of a structure, but may instead want to focus on details related or otherwise limited to certain components of the structure. Similarly, the UAV operator may want to have a semantic understanding of the structure that goes beyond what geometries can convey. For example, the UAV operator may want to understand what the specific components of the structure are, distinguishing between similar components (e.g., first and second blades of a wind turbine).

These scan approaches and the resulting 3D geometric reconstructions of structures do not convey such semantic understandings. In particular, because they merely output geometric information for the structure, they do not identify individual components or distinguish between components of the same type. Thus, UAV operators today must perform some manual process to denote structure components from one another. Typically, this involves a time consuming, labor intensive, and error prone process of a UAV operator entering data in connection UAV-captured images depicting portions of a structure, such as to catalog which components are shown in which images. Previous attempts at automating this task have, however, suffered drawbacks due to the technical challenge of adding image-level metadata to captured images based on an intended capture plan given the importance of understanding location-specific component information. For example, one such attempt has used markers or identification plates visible within images to link the detection of those markers or identification plates with certain structures. However, this approach only enables the identification of a structure, and thus cannot result in a precise location of the structure or its components being determined, and it is also only applicable to a small number of structures that use these markers or identification plates.

Implementations of this disclosure address problems such as these using semantic segmentation rendering for precise localization of structure components on captured images. Semantic segmentation rendering includes encoding structural data in pixel values of an image, so that structure components and their relative locations can be identified by the image encodings themselves. A UAV performs an exploration inspection of a site which includes one or more structures to capture images of the one or more structures. For each image, each pixel value of the image has encoded therein identifiers associated with one or more of the structure it corresponds to, the component it corresponds to, and a location of that component. A 3D graphical representation of the site is updated using shaders to visually distinguish the detected components of the one or more structures according to the encoded identifiers, and semantic annotations corresponding to those shaders are stored for further inspection use by the same or a different UAV. Thus, according to the implementations of this disclosure, a UAV is able to process images captured in flight, automatically determine what structures and components are visible in the images as well as their precise locations, and integrate this visual data in a cloud database for use in further inspections of those structures.

Generally, the quality of a scan (i.e., an inspection or an operation of an inspection) being “semantic” refers to the scan incorporating information and processing to recognize detailed contextual information for a structure and components thereof. In particular, a UAV performing a semantic 3D scan for a structure inspection uses machine learning to generate a comprehensive taxonomy of components of a structure, either starting from a blank list of components or an empirically (e.g., templatized) determined default list of components. The taxonomical information enables the operator of the UAV to identify components of the structure for a further, detailed inspection using the UAV. The taxonomical information thus readily identifies components of relevance to a given inspection from amongst a generally or near exhaustive listing of components scanned via the first phase inspection. This semantic understanding of structures and components enables valuable automations for UAV-based structure inspections, improving the accuracy of captured data and materially reducing time and media capture requirements of other scan approaches. For example, a semantic understanding of a structure component may indicate to the UAV information about the component (e.g., its type, location, material, etc.) and/or its relationship to the structure and/or other components thereof.

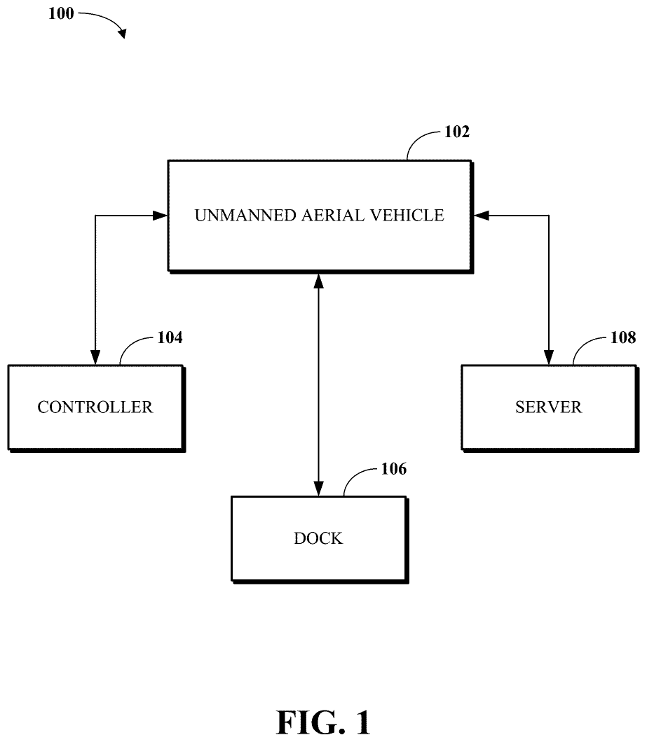

To describe some implementations in greater detail, reference is first made to examples of hardware and software structures used to implement a semantic segmentation rendering system. FIG. 1 is an illustration of an example of a UAV system 100. The system 100 includes a UAV 102, a controller 104, a dock 106, and a server 108.

The UAV 102 is a vehicle which may be controlled autonomously by one or more onboard processing aspects or remotely controlled by an operator, for example, using the controller 104. The UAV 102 may be implemented as one of a number of types of unmanned vehicle configured for aerial operation. For example, the UAV 102 may be a vehicle commonly referred to as a drone but may otherwise be an aircraft configured for flight within a human operator present therein. In particular, the UAV 102 may be a multi-rotor vehicle. For example, the UAV 102 may be lifted and propelled by four fixed-pitch rotors in which positional adjustments in-flight may be achieved by varying the angular velocity of each of those rotors.

The controller 104 is a device configured to control at least some operations associated with the UAV 102. The controller 104 may communicate with the UAV 102 via a wireless communications link (e.g., via a Wi-Fi network, a Bluetooth link, a ZigBee link, or another network or link) to receive video or images and/or to issue commands (e.g., take off, land, follow, manual controls, and/or commands related to conducting an autonomous or semi-autonomous navigation of the UAV 102). The controller 104 may be or include a specialized device. Alternatively, the controller 104 may be or include a mobile device, for example, a smartphone, tablet, laptop, or other device capable of running software configured to communicate with and at least partially control the UAV 102.

The dock 106 is a structure which may be used for takeoff and/or landing operations of the UAV 102. In particular, the dock 106 may include one or more fiducials usable by the UAV 102 for autonomous takeoff and landing operations. For example, the fiducials may generally include markings which may be detected using one or more sensors of the UAV 102 to guide the UAV 102 from or to a specific position on or in the dock 106. In some implementations, the dock 106 may further include components for charging a battery of the UAV 102 while the UAV 102 is on or in the dock 106. The dock 106 may be a protective enclosure from which the UAV 102 is launched. A location of the dock 106 may correspond to the launch point of the UAV 102.

The server 108 is a remote computing device from which information usable for operation of the UAV 102 may be received and/or to which information obtained at the UAV 102 may be transmitted. For example, the server 108 may be used to train a learning model usable by one or more aspects of the UAV 102 to implement functionality of the UAV 102. In another example, signals including information usable for updating aspects of the UAV 102 may be received from the server 108. The server 108 may communicate with the UAV 102 over a network, for example, the Internet, a local area network, a wide area network, or another public or private network.

In some implementations, the system 100 may include one or more additional components not shown in FIG. 1. In some implementations, one or more components shown in FIG. 1 may be omitted from the system 100, for example, the server 108.

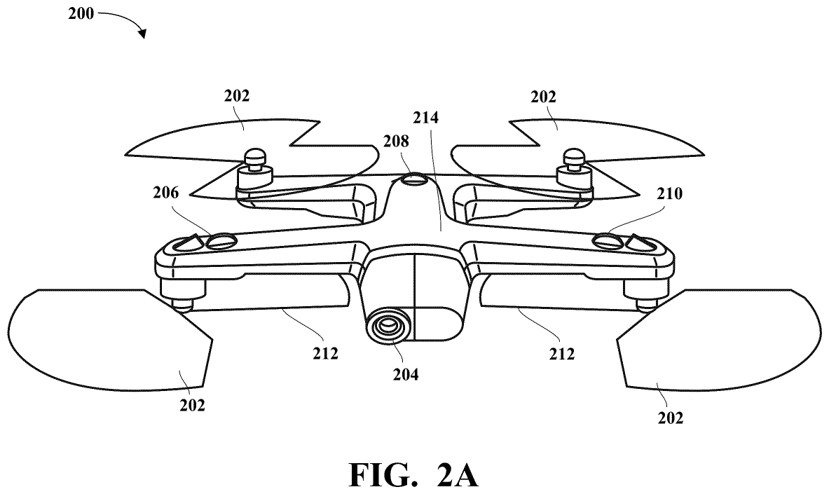

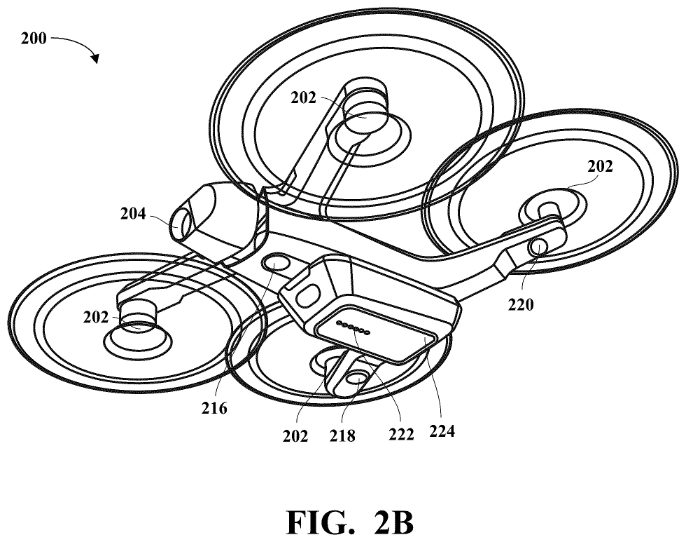

An example illustration of a UAV 200, which may, for example, be the UAV 102 shown in FIG. 1, is shown in FIGS. 2A-B. FIG. 2A is an illustration of an example of the UAV 200 as seen from above. The UAV 200 includes a propulsion mechanism 202 including some number of propellers (e.g., four) and motors configured to spin the propellers. For example, the UAV 200 may be a quad-copter drone. The UAV 200 includes image sensors, including a high-resolution image sensor 204. This image sensor 204 may, for example, be mounted on a gimbal to support steady, low-blur image capture and object tracking. The UAV 200 also includes image sensors 206, 208, and 210 that are spaced out around the top of the UAV 200 and covered by respective fisheye lenses to provide a wide field of view and support stereoscopic computer vision. The image sensors 206, 208, and 210 generally have a resolution which is lower than a resolution of the image sensor 204. Additionally, the UAV 200 includes a number of arms 212 (e.g., four). The propulsion mechanisms 202 may be mounted to the arms 212. The arms 212 are attached the body 214 of the UAV 200. The propulsion mechanisms 202, the arms 212, and the body 214 may collectively be referred to as the frame of the UAV 200. The UAV 200 also includes other internal hardware, for example, a processing apparatus (not shown). In some implementations, the processing apparatus is configured to automatically fold the propellers when entering a dock (e.g., the dock 106 shown FIG. 1), which may allow the dock to have a smaller footprint than the area swept out by the propellers of the propulsion mechanism 202.

FIG. 2B is an illustration of an example of the UAV 200 as seen from below. From this perspective, three more image sensors 216, 218, and 220 arranged on the bottom of the UAV 200 may be seen. These image sensors 216, 218, and 220 may also be covered by respective fisheye lenses to provide a generally wide field of view and support stereoscopic computer vision. The various image sensors of the UAV 200 may enable visual inertial odometry (VIO) for high resolution localization and obstacle detection and avoidance. For example, the image sensors may be used to capture images including infrared data which may be processed for day or night mode navigation of the UAV 200. The UAV 200 also includes a battery in battery pack 224 attached on the bottom of the UAV 200, with conducting contacts 222 to enable battery charging. The bottom surface of the battery pack 224 may be a bottom surface of the UAV 200.

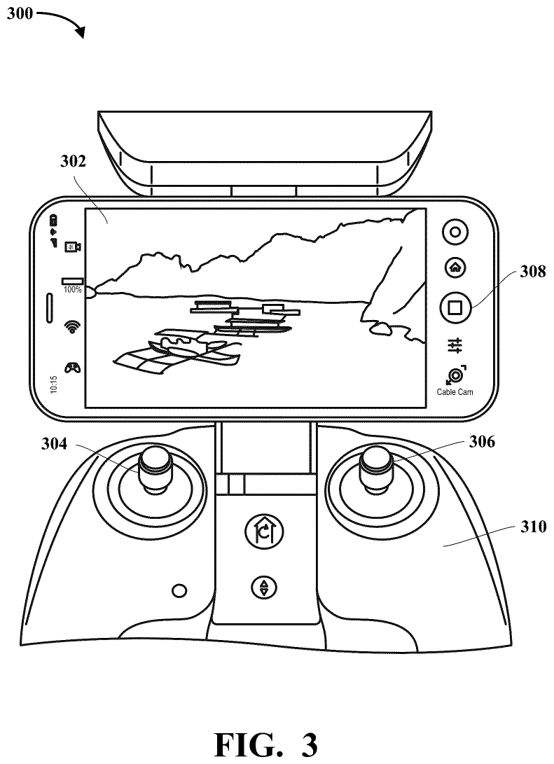

FIG. 3 is an illustration of an example of a controller 300 for a UAV, which may, for example, be the UAV 102 shown in FIG. 1. The controller 300 may, for example, be the controller 104 shown in FIG. 1. The controller 300 may provide a user interface for controlling the UAV and reviewing data (e.g., images) received from the UAV. The controller 300 includes a touchscreen 302, a left joystick 304, and a right joystick 306. In the example as shown, the touchscreen 302 is part of a mobile device 308 (e.g., a smartphone) that connects to a controller attachment 310, which, in addition to providing additional control surfaces including the left joystick 304 and the right joystick 306, may provide range extending communication capabilities for longer distance communication with the UAV.

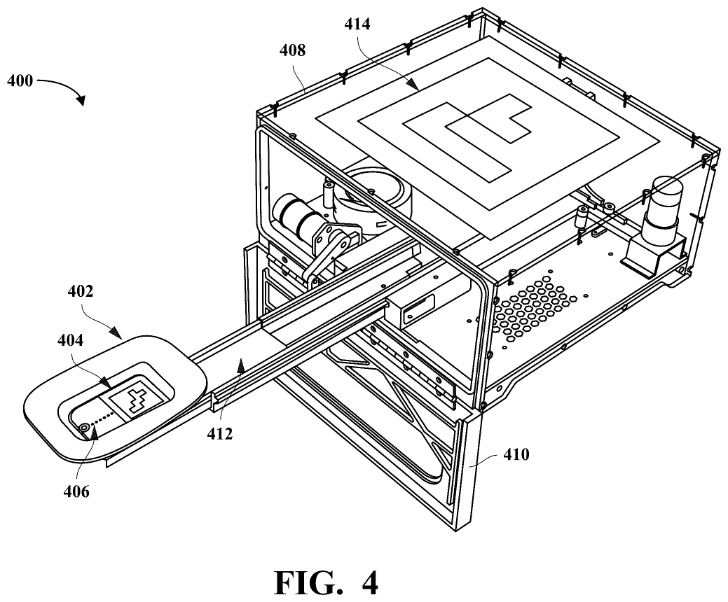

FIG. 4 is an illustration of an example of a dock 400 for facilitating autonomous landing of a UAV, for example, the UAV 102 shown in FIG. 1. The dock 400 may, for example, be the dock 106 shown in FIG. 1. The dock 400 includes a cradle 402 (i.e., landing surface) with a fiducial 404, charging contacts 406 for a battery charger, a box 408 in the shape of a rectangular box with a door 410, and a retractable arm 412.

The cradle 402 is configured to hold a UAV. The UAV may be configured for autonomous landing on the cradle 402. The cradle 402 has a funnel geometry shaped to fit a bottom surface of the UAV at a base of the funnel. The tapered sides of the funnel may help to mechanically guide the bottom surface of the UAV into a centered position over the base of the funnel during a landing. For example, corners at the base of the funnel may serve to prevent the aerial vehicle from rotating on the cradle 402 after the bottom surface of the aerial vehicle has settled into the base of the funnel shape of the cradle 402. For example, the fiducial 404 may include an asymmetric pattern that enables robust detection and determination of a pose (i.e., a position and an orientation) of the fiducial 404 relative to the UAV based on an image of the fiducial 404, for example, captured with an image sensor of the UAV.

The conducting contacts 406 are contacts of a battery charger on the cradle 402, positioned at the bottom of the funnel. The dock 400 includes a charger configured to charge a battery of the UAV while the UAV is on the cradle 402. For example, a battery pack of the UAV (e.g., the battery pack 224 shown in FIG. 2B) may be shaped to fit on the cradle 402 at the bottom of the funnel shape. As the UAV makes its final approach to the cradle 402, the bottom of the battery pack will contact the cradle 402 and be mechanically guided by the tapered sides of the funnel to a centered location at the bottom of the funnel. When the landing is complete, the conducting contacts of the battery pack may come into contact with the conducting contacts 406 on the cradle 402, making electrical connections to enable charging of the battery of the UAV. The dock 400 may include a charger configured to charge the battery while the UAV is on the cradle 402.

The box 408 is configured to enclose the cradle 402 in a first arrangement and expose the cradle 402 in a second arrangement. The dock 400 may be configured to transition from the first arrangement to the second arrangement automatically by performing steps including opening the door 410 of the box 408 and extending the retractable arm 412 to move the cradle 402 from inside the box 408 to outside of the box 408.

The cradle 402 is positioned at an end of the retractable arm 412. When the retractable arm 412 is extended, the cradle 402 is positioned away from the box 408 of the dock 400, which may reduce or prevent propeller wash from the propellers of a UAV during a landing, thus simplifying the landing operation. The retractable arm 412 may include aerodynamic cowling for redirecting propeller wash to further mitigate the problems of propeller wash during landing. The retractable arm supports the cradle 402 and enables the cradle 402 to be positioned outside the box 408, to facilitate takeoff and landing of a UAV, or inside the box 408, for storage and/or servicing of a UAV.

In some implementations, the dock 400 includes a fiducial 414 on an outer surface of the box 408. The fiducial 404 and the fiducial 414 may be detected and used for visual localization of the UAV in relation the dock 400 to enable a precise landing on the cradle 402. For example, the fiducial 414 may encode data that, when processed, identifies the dock 400, and the fiducial 404 may encode data that, when processed, enables robust detection and determination of a pose (i.e., a position and an orientation) of the fiducial 414 relative to the UAV. The fiducial 414 may be referred to as a first fiducial and the fiducial 404 may be referred to as a second fiducial. The first fiducial may be larger than the second fiducial to facilitate visual localization from farther distances as a UAV approaches the dock 400. For example, the area of the first fiducial may be 25 times the area of the second fiducial.

The dock 400 is shown by example only and is non-limiting as to form and functionality. Thus, other implementations of the dock 400 are possible. For example, other implementations of the dock 400 may be similar or identical to the examples shown and described within U.S. patent application Ser. No. 17/889,991, filed Aug. 31, 2022, the entire disclosure of which is herein incorporated by reference.

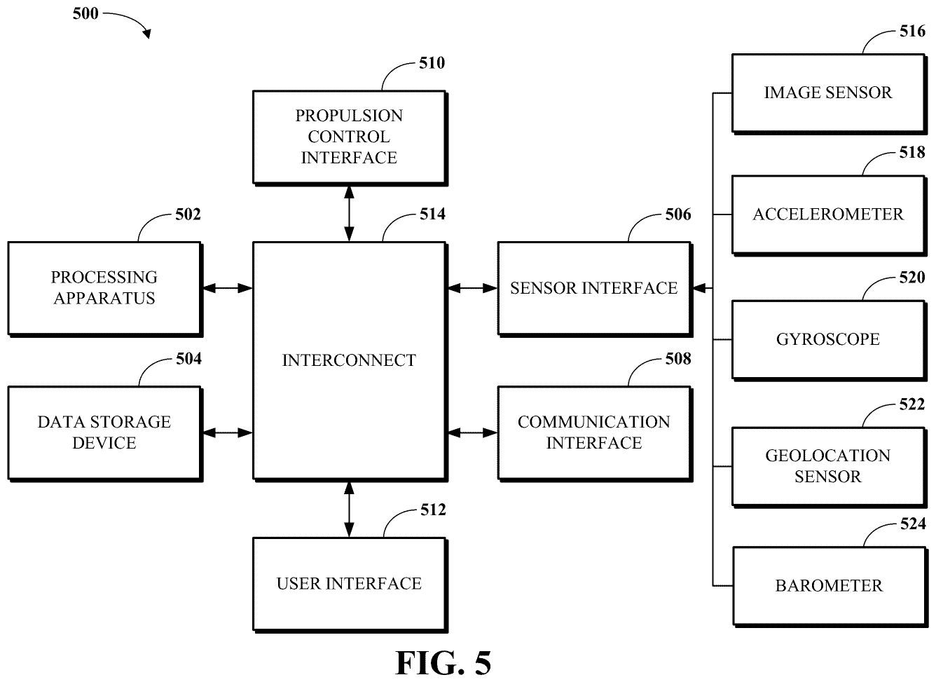

FIG. 5 is a block diagram of an example of a hardware configuration of a UAV 500, which may, for example, be the UAV 102 shown in FIG. 1. The UAV 500 includes a processing apparatus 502, a data storage device 504, a sensor interface 506, a communications interface 508, propulsion control interface 510, a user interface 512, and an interconnect 514 through which the processing apparatus 502 may access the other components.

The processing apparatus 502 is operable to execute instructions that have been stored in the data storage device 504 or elsewhere. The processing apparatus 502 is a processor with random access memory (RAM) for temporarily storing instructions read from the data storage device 504 or elsewhere while the instructions are being executed. The processing apparatus 502 may include a single processor or multiple processors each having single or multiple processing cores. Alternatively, the processing apparatus 502 may include another type of device, or multiple devices, capable of manipulating or processing data. The processing apparatus 502 may be arranged into processing unit, such as a central processing unit (CPU) or a graphics processing unit (GPU).

The data storage device 504 is a non-volatile information storage device, for example, a solid-state drive, a read-only memory device (ROM), an optical disc, a magnetic disc, or another suitable type of storage device such as a non-transitory computer readable memory. The data storage device 504 may include another type of device, or multiple devices, capable of storing data for retrieval or processing by the processing apparatus 502. The processing apparatus 502 may access and manipulate data stored in the data storage device 504 via the interconnect 514, which may, for example, be a bus or a wired or wireless network (e.g., a vehicle area network).

The sensor interface 506 is configured to control and/or receive data from one or more sensors of the UAV 500. The data may refer, for example, to one or more of temperature measurements, pressure measurements, a global positioning system (GPS) data, acceleration measurements, angular rate measurements, magnetic flux measurements, a visible spectrum image, an infrared image, an image including infrared data and visible spectrum data, and/or other sensor output. For example, the one or more sensors from which the data is generated may include single or multiple of one or more of an image sensor 516, an accelerometer 518, a gyroscope 520, a geolocation sensor 522, a barometer 524, and/or another sensor. In some implementations, the accelerometer 518 and the gyroscope 520 may be combined as an inertial measurement unit (IMU). In some implementations, the sensor interface 506 may implement a serial port protocol (e.g., inter-integrated circuit (I2C) or serial peripheral interface (SPI)) for communications with one or more sensor devices over conductors. In some implementations, the sensor interface 506 may include a wireless interface for communicating with one or more sensor groups via low-power, short-range communications techniques (e.g., using a vehicle area network protocol).

The communications interface 508 facilitates communication with one or more other devices, for example, a paired dock (e.g., the dock 106), a controller (e.g., the controller 104), or another device, for example, a user computing device (e.g., a smartphone, tablet, or other device). The communications interface 508 may include a wireless interface and/or a wired interface. For example, the wireless interface may facilitate communication via a Wi-Fi network, a Bluetooth link, a ZigBee link, or another network or link. In another example, the wired interface may facilitate communication via a serial port (e.g., RS-232 or universal serial bus (USB)). The communications interface 508 further facilitates communication via a network, which may, for example, be the Internet, a local area network, a wide area network, or another public or private network.

The propulsion control interface 510 is used by the processing apparatus to control a propulsion system of the UAV 500 (e.g., including one or more propellers driven by electric motors). For example, the propulsion control interface 510 may include circuitry for converting digital control signals from the processing apparatus 502 to analog control signals for actuators (e.g., electric motors driving respective propellers). In some implementations, the propulsion control interface 510 may implement a serial port protocol (e.g., I2C or SPI) for communications with the processing apparatus 502. In some implementations, the propulsion control interface 510 may include a wireless interface for communicating with one or more motors via low-power, short-range communications (e.g., a vehicle area network protocol).

The user interface 512 allows input and output of information from/to a user. In some implementations, the user interface 512 can include a display, which can be a liquid crystal display (LCD), a light emitting diode (LED) display (e.g., an organic light-emitting diode (OLED) display), or another suitable display. In some such implementations, the user interface 512 may be or include a touchscreen. In some implementations, the user interface 512 may include one or more buttons. In some implementations, the user interface 512 may include a positional input device, such as a touchpad, touchscreen, or the like, or another suitable human or machine interface device.

In some implementations, the UAV 500 may include one or more additional components not shown in FIG. 5. In some implementations, one or more components shown in FIG. 5 may be omitted from the UAV 500, for example, the user interface 512.

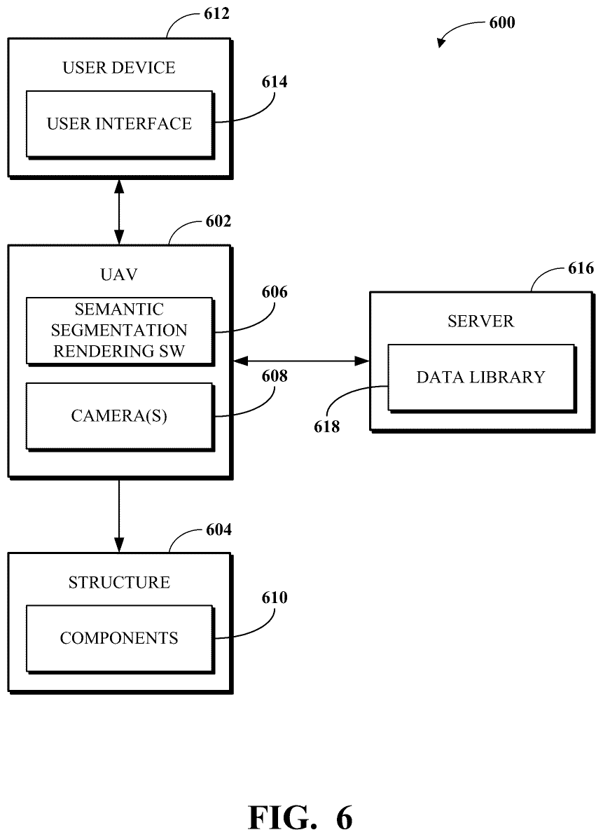

FIG. 6 is a block diagram of an example of a semantic segmentation rendering system 600. The system 600 includes a UAV 602 and a structure 604 to be inspected using the UAV 602. The UAV 602 may, for example, be the UAV 102 shown in FIG. 1, the UAV 200 shown in FIGS. 2A-B, and/or the UAV 500 shown in FIG. 5. The structure 604 is a physical, 3D structural object that can be wholly or partially flown around by the UAV 602. Non-limiting examples of the structure 604 include buildings (e.g., residential, commercial, or industrial, including internal portions (e.g., warehouse aisles)), bridges (e.g., utility, walkway, or roadway), towers (e.g., powerline transmission, radio, cellular, or water), energy equipment (e.g., sub-stations, wind turbines, solar cells or farms, or power plant cooling towers), vehicles (e.g., aircraft, marine vessels, spacecraft, or land vehicles), civil spaces (e.g., parks or parking lots), and geographic features (e.g., forests, bluffs, mountains, valleys, or ravines). In some cases, the structure 604 may include a living being rather than or in addition to an object as described above. Non-limiting examples of the living being in such a case include humans, animals, fungi, and plants.

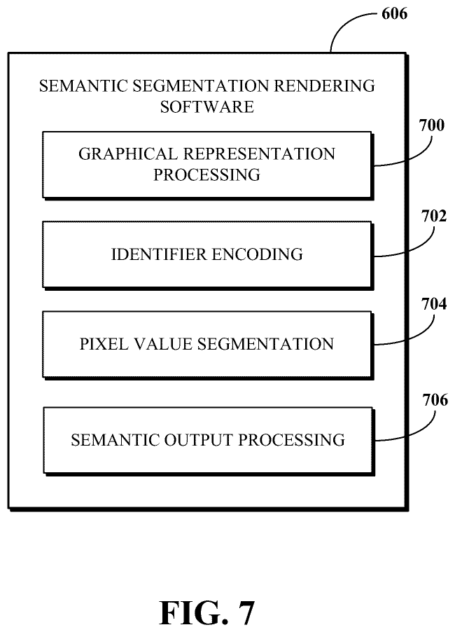

The UAV 602 includes hardware and software that configure the UAV 602 to determine a semantic understanding and perform semantic segmentation for a rendering of the structure 604 via an exploration inspection thereof. In particular, and in addition to other components as are described with respect to FIG. 5, the UAV 602 includes semantic segmentation and rendering software 606 and one or more cameras 608. The semantic segmentation and rendering software 606, which will be described further in connection with FIG. 7, includes functionality for enabling the UAV 602 to perform an exploration inspection of the structure 604 to capture one or more images of the structure 604 using the one or more cameras 608, encode identifiers associated with components 610 of the structure 604 within pixel values of the one or more images, segment the pixel values into polygons according to the encoded identifiers, and communicate (e.g., to a user device 612, via a user interface 614, or to a server 616) semantic output associated with the components 610 for use in a further inspection of the components 610.

The components 610 generally are, include, or otherwise refer to components (e.g., objects, elements, pieces, equipment, sub-equipment, tools, or other physical matter) on or within the structure 604. In one non-limiting example, where the structure 604 is a powerline transmission tower, the components 610 may include one or more of an insulator, a static line or connection point, a conductor or overhead wire, a footer, or a transformer). The structure 604 may include any number of types of the components 610 and any number of ones of the components 610 for each of the individual types thereof.

The user device 612 is a computing device configured to communicate with the UAV 602 wirelessly or by wire. For example, the user device 612 may be one or more of the controller 104 shown in FIG. 1 or the controller 300 shown in FIG. 3. In some cases, the UAV performs the exploration inspection of the structure 604 using input obtained from the user device 612. For example, the input obtained from the user device 612 may include information specifying one or more of the components 610 to inspect, a height at which the UAV 602 will fly while traversing along a flight path, a distance for the UAV 602 to fly, a maximum speed for the UAV 602 to fly, a radius that the UAV 602 will use to orbit or otherwise explore and evaluate the structure 604, a gimbal angle for the one or more cameras 608, a column path for the flight path, an instruction for data capture at waypoints of the flight path, or an instruction for stopping the inspection of the structure 604.

In some cases, the user of the user device 612 may specify one or more configurations for controlling the capture of some or all of the one or more images during the exploration inspection. For example, user input may be obtained from the user device 612 (e.g., via the user interface 614, which may, for example, include one or more graphical user interfaces (GUIs) for input collection) to configure the UAV to capture a single image for each component of the structure, to capture N images of the structure each from a different manually-specified or automatically-determined angle (i.e., where N is an integer greater than 1), to capture images from a specified ground sampling distance (GSD) (e.g., using the same GSD for the entire exploration inspection or using different GSDs for different portions of the structure), or the like.

The UAV 602, via the semantic segmentation and rendering software 606, may utilize empirical and/or machine learning-based data modeled for use in structure inspections. In particular, the UAV 602 may communicate with the server 616, which includes a data library 618 usable by or otherwise in connection with the semantic segmentation and rendering software 606 to store semantic output generated using the semantic segmentation and rendering software 606 and/or to serve, according to such stored semantic output, responses to queries for images that depict the structure 604 or one or more of the components 610. The server 616 is a computing device remotely accessible by or otherwise to the UAV 602. The data library 618 may, for example, include one or more of semantic output generated for the structure 604 and/or other structures, historic inspection data for the structure 604 and/or the other structures, machine learning models (e.g., classification engines comprising trained convolutional or deep neural networks) trained according to inspection image output data sets with user-specific information culled, and/or other information usable by the system 600. In some cases, the data library 618 or other aspects at the server 616 may be accessed by or otherwise using the user device 612 instead of the UAV 602.

To further describe functionality of the semantic segmentation and rendering software 606, reference is next made to FIG. 7, which is a block diagram of example functionality of the semantic segmentation and rendering software 606. The semantic segmentation and rendering software 606, as described above, may use various functionality of a UAV (e.g., the UAV 602 shown in FIG. 6) to cause the UAV to generate semantic output based on encoded identifiers of pixel values of images captured for a site including one or more structures, for example, the structure 604 shown in FIG. 6. The semantic segmentation and rendering software 606 includes a graphical representation processing tool 700, an identifier encoding tool 702, a pixel value segmentation tool 704, and a semantic output processing tool 706. The tools 700 through 706 represent various functionality of the semantic segmentation and rendering software 606 and are non-limiting as to a particular structure or other expression of code, script, or the like. While the semantic segmentation and rendering software 606 may be used to sequentially or simultaneously process semantic output for multiple structures at a site, the semantic segmentation and rendering software 606 will be described with respect to processing semantic output for a single structure.

The graphical representation processing tool 700 obtains a 3D graphical representation of a structure under inspection. The 3D graphical representation is a visual model of the structure and may, for example, be a parametric 3D model. The graphical representation processing tool 700 obtains the 3D graphical representation of the structure either by generating the 3D graphical representation or by importing the 3D graphical representation, for example, via a computer-aided design (CAD) system. Where the graphical representation processing tool 700 generates the 3D graphical representation of the structure, the graphical representation processing tool 700 does so using, as input, one or more images of the structure captured using a UAV while the UAV orbits around some or all of the structure. Orbiting around the structure may, for example, include the UAV circling the structure, navigating along a perimeter or like boundary of the structure, or otherwise exploring the structure from a distance. In some cases, the orbiting can follow a zig-zag, lawnmower, or other pattern around the structure. The orbiting may be performed at one or more altitudes relative to the structure.

The graphical representation processing tool 700 generates the 3D graphical representation of the structure based on the one or more images using a ray-based optimization technique. The ray-based optimization technique is a technique for using rays to determine where information passes through the one or more images on a per pixel basis. In particular, a ray as used by such a ray-based optimization technique is a linear projection that intersects an image at a single pixel. Each pixel is associated with a different ray. The rays are grouped together to derive understandings of objects according to their shapes, sizes, and relative locations. For example, the ray-based optimization technique may be a graph clustering technique that measures the relative scores of clusters of rays, in which each ray represents or otherwise corresponds to a node of a graph. In particular, with a graph clustering technique, distances are measured each between a given pair of rays in physical space. Those distances are modeled using empirical understandings via semantic segmentation modeling and/or machine learning model-based (e.g., deep learning-based) classifications to infer a component type for an object depicted in an image of the one or more images.

In addition to the pixel content of the one or more images, the graphical representation processing tool 700 obtains location information for the various objects detected within the one or more images via the ray-based optimization described above. For example, the location information may be expressed in 3D space using XYZ coordinates and determined using pose information of the UAV to capture the one or more images alongside one or more of a visual positioning system (VPS) of the UAV used, GPS, or another location-based system. The location information is used by the ray-based optimization technique to recognize same objects depicted in different images of the one or more images, noting that such depictions of a same object may vary according to a given pose taken by the UAV at the time of image capture. For example, the location information may be determined using the VPS, GPS, or other location-based system via a triangulation process performed at the UAV.

The output of the graphical representation processing tool 700 thus includes a 3D graphical representation of the structure, identifications within the 3D graphical representation of components of the structure, and location information for the structure and its components. In particular, the result of the ray-based optimization technique includes a set of points in 3D space that may be represented as a 3D model such as a point cloud, which may be fitted with 3D a parametric model to finetune parameters of the 3D model, to result in the 3D graphical representation of the structure. The 3D graphical representation thus operates in place of bounding boxes, cuboids, or the like. In some cases, finetuning the parameters of the 3D model can include detecting key points in the images of the structure and matching those detected key points with the respective key points of the 3D model by running a genetic algorithm that updates the parameters of the 3D model. Non-limiting examples of parameters which may be finetuned in this way include dimensions of individual components (e.g., height, width, and/or depth), twists or bends and tolerances therefor for individual components, rotations (e.g., pitch, roll, and/or yaw) for individual components, and the like.

The identifier encoding tool 702 processes the one or more images of the structure that were captured using the UAV to encode one or more identifiers in some or all pixel values of some or all of those one or more images. In particular, in each pixel value that corresponds to the structure within the one or more images, identifiers of the structure, of a component of the structure depicted using the pixel value, and of a location of the component are encoded. In some cases, some, but not all of those identifiers may be encoded in the respective pixel values. In some cases, additional identifiers may be encoded in respective pixel values. For example, the additional identifiers may indicate context of a component depicted by a respective pixel value, such as whether the pixel value is of a top or bottom surface of the component Encoding the identifiers in a pixel value includes generating metadata indicative of the identifiers and associating that metadata with the pixel value.

The identifier encoding tool 702 encodes the identifiers in the respective pixel values as part of a process for rendering the 3D graphical representation of the structure with shaders for visually distinguishing between components of the structure. Thus, simultaneous or sequential processing may occur between the identifier encoding tool 702 and the graphical representation processing tool 700. In particular, for each image of the structure, the graphical representation processing tool 700, using a 3D engine, renders one or more portions of the 3D graphical representation, each portion corresponding to one or more components of the structure, with respective shaders. In one non-limiting example, the shaders may each be or otherwise correspond to different colors or shading styles. For example, the 3D engine may render the one or more portions of the 3D graphical representation for a given image by first encoding an identifier of the structure in some or all pixel values of the image and thereafter encoding other identifiers in those pixel values. For example, the other identifiers may include component identifiers, location identifiers, or other identifiers.

Rendering the 3D graphical representation of the structure includes generating a UV map of the structure according to the shaders used for the respective components of the structure and then rendering the 3D graphical representation of the structure based on the UV map. The UV map is a two-dimensional (2D) representation of the pixel values depicting the structure from the images captured using the UAV. In particular, the UV map identifies an arrangement of the components of the structure based on shaders used for those components. The 3D graphical representation of the structure may be rendered based on the UV map by projecting the UV map onto a surface of the 3D graphical representation, in which different indices, or points, of the UV map are related to different locations on the 3D graphical representation. Thus, the identifier encoding tool 702 may encode, as the other identifiers in respective pixel values, UV map indices of those pixel values. Ultimately, the encoding of the identifiers in the pixel values enables those pixel values to indicate semantic information of the structure and its components.

The pixel value segmentation tool 704 segments the pixel values of the images into polygons of the 3D graphical representation of the structure according to the identifiers encoded in the pixel values using the identifier encoding tool 702. Segmenting the pixel values into the polygons includes performing a computer vision process to segment the data of the pixel values into vector annotations representing the polygons. For example, the computer vision process may be or include panoptic segmentation performed to identify classes of pixel content while distinguishing between instances of such classes elsewhere in the image data. Thus, individual components of the same type of the structure may be separately identified and accordingly distinguished using panoptic segmentation, making it a valuable computer vision process for uniquely identifying structure components by their types and locations. The pixel value segmentation tool 704 accordingly operates to separately identify components by polygon based on their encoded identifiers.

The semantic output processing tool 706 processes the output of the semantic segmentation and rendering software 606. In particular, the semantic output processing tool 706 operates to cause a storage of data indicative of the polygons in a data store for use in a further inspection of the structure at a same or later date as when the pixel values are segmented into the polygons. In some cases, the data indicative of the polygons identifies respective ones of the shaders used for the components of the structure. For example, the data indicative of the polygons may include the UV map generated for the structure. The data store in which the data indicative of the polygons is stored may, for example, be a server-side (i.e., cloud-based) data store accessible by the UAV and/or the user device and one or more other UAVs and/or user devices in communication therewith. Alternatively, or additionally, the semantic output processing tool 706 may operate to cause the user device in communication with the UAV to output data associated with the 3D graphical representation of the structure at the user device.

The semantic segmentation and rendering software 606 is shown and described as being run (e.g., executed, interpreted, or the like) at a UAV used to perform an inspection of a structure. However, in some cases, the semantic segmentation and rendering software 606 or one or more of the tools 700 through 706 may be run other than at the UAV. For example, one or more of the tools 700 through 706 may be run at a user device or a server device and the output thereof may be communicated to the UAV for processing.

In some implementations, the UV map generated as part of the rendering of the 3D graphical representation of the structure using the graphical representation processing tool 700 can be used to determine a flight path for inspecting the structure according to relative locations of the components represented within the indices of the UV map. For example, the UAV, via the semantic segmentation and rendering software (e.g., via the semantic output processing tool 706 or another tool) may automatically determine the flight path and present it on the UV map as an overlay. In another example, the user of a user device in wired or wireless communication with the UAV may, via a GUI that outputs the UV map for display at the user device, trace or otherwise indicate the flight path for the structure directly on the UV map.

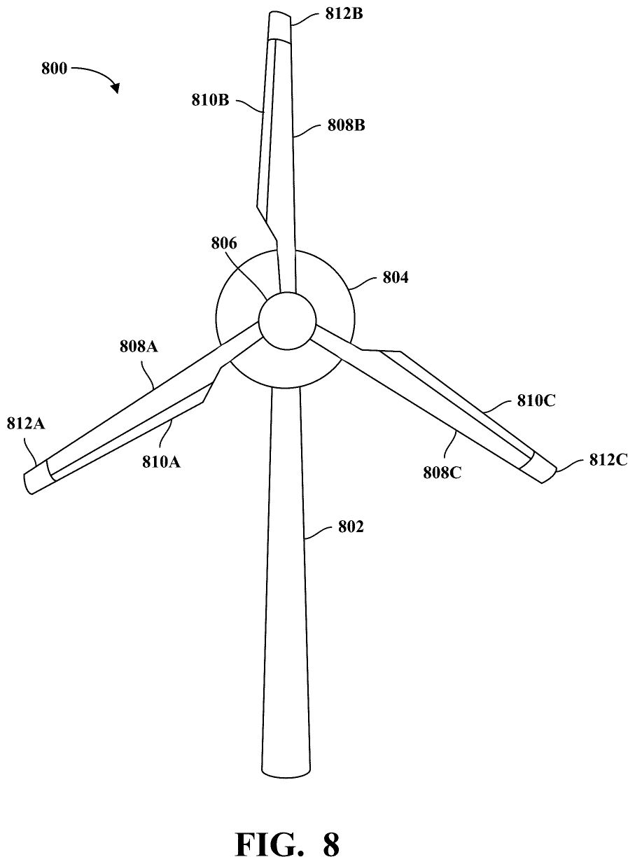

FIG. 8 is an illustration of an example of a structure 800 and its components for which semantic output may be generated. In particular, the structure 800 in the example shown is a wind turbine. The wind turbine includes several components identified by the graphical representation processing of images captured using a UAV, such as described above with respect to the semantic segmentation and rendering software 606. As shown, the structure 800 includes a tower 802, a nacelle 804, a rotor and hub 806, and three blade assemblies, each including a leading edge (808A, 808B, 808C), a trailing edge (810A, 810B, 810C), and a tip (812A, 812B, 812C). Images of the structure 800 are processed as described with respect to FIG. 7 to identify each of the components 802 through 812A-C and to encode identifiers in pixel values depicting ones of the components 802 through 812A-C. This enables the rendering of those components 802 through 812A-C in a 3D graphical representation of the structure 800 using different shaders to visually distinguish between the components 802 through 812A-C. For example, unique shaders may be used for each individual component of the structure 800 such that no two components 802 through 812A-C share a same shader. This includes components of a same type—thus, representations of the leading edges 808A, 808B, and 808C within the 3D graphical representation of the structure 800 are rendered using three different shaders.

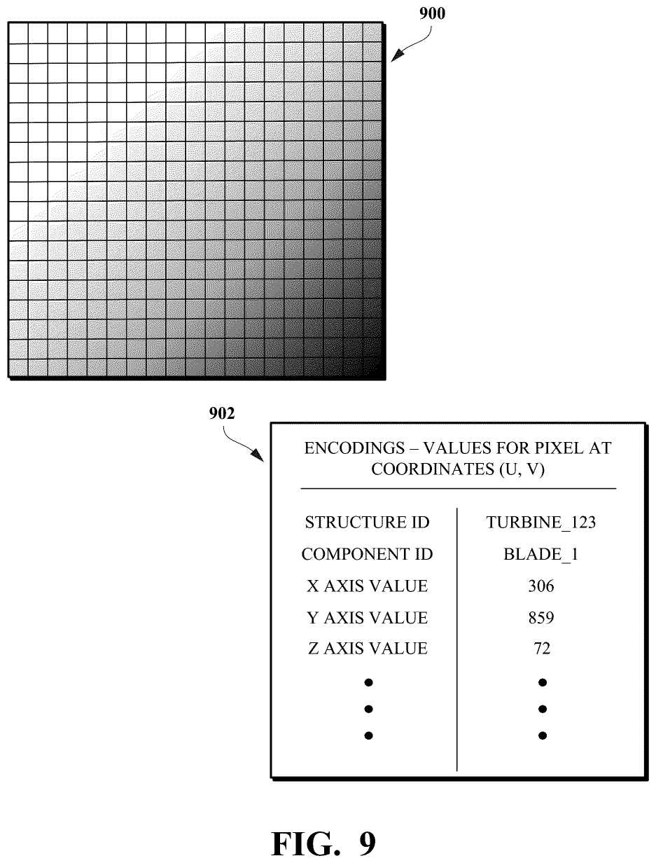

FIG. 9 is an illustration of an example of a UV map 900 for a structure and encodings 902 for a pixel value corresponding to a portion of the structure. The UV map is a two-dimensional representation of surface content of a 3D graphical representation of a structure, in this case, the structure 800 shown in FIG. 8. The colors shown and the locations of those colors in the UV map 900 correspond to the shaders and the components on which the shaders are used of the structure 800. Noting that the structure 800 is depicted in FIG. 8 in black and white, the UV map 900 simply demonstrates one example of how the shader contents may appear in a UV map. Moreover, the particular arrangement of shaders in the UV map 900 is, as described above, based on the locations of the components that use those shaders, and so the arrangement of the colors illustrated in the UV map 900 is by example only. Separately, the encodings 902 represent an example visualization of the encoded identifiers for a pixel value of the structure 800, which pixel value is located at coordinates (U, V) of the UV map 900. As shown, the encodings 902 indicate a structure identifier for the pixel value, a component identifier for the pixel value, and XYZ coordinates of the pixel value in some 3D space range, an index of the pixel value within the UV map 900.

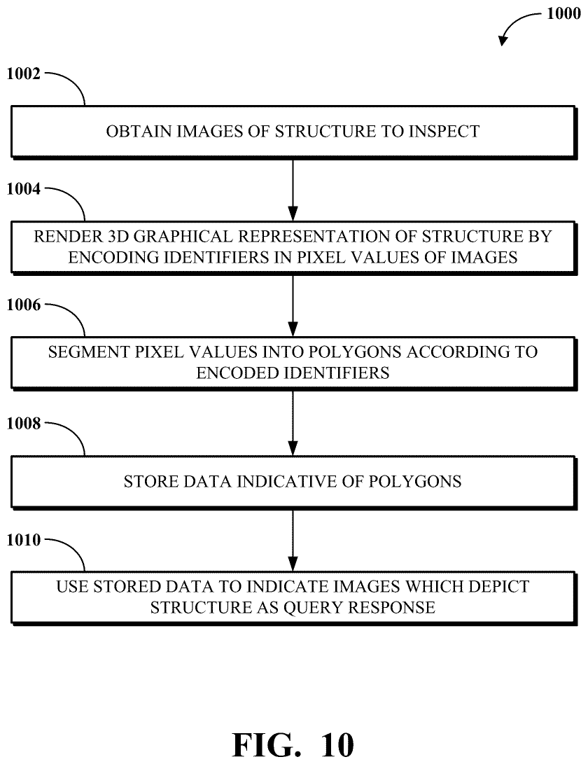

To further describe some implementations in greater detail, reference is next made to examples of techniques for semantic segmentation rendering. FIG. 10 is a flowchart of an example of a technique 1000 for semantic segmentation rendering for precise localization of structure components on captured images. The technique 1000 can be executed using computing devices, such as the systems, hardware, and software described with respect to FIGS. 1-9. The technique 1000 can be performed, for example, by executing a machine-readable program or other computer-executable instructions, such as routines, instructions, programs, or other code. The steps, or operations, of the technique 1000 or another technique, method, process, or algorithm described in connection with the implementations disclosed herein can be implemented directly in hardware, firmware, software executed by hardware, circuitry, or a combination thereof.

For simplicity of explanation, the technique 1000 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1002, one or more images of a structure are obtained. The one or more images are captured using a UAV during an exploration inspection of the structure. In some cases, the one or more images may be of multiple structures at a site.

At 1004, a 3D graphical representation of the structure is obtained and rendered by encoding identifiers in pixel values of the one or more images. In particular, in each pixel value that corresponds to the structure within the images, identifiers are encoded. The identifiers include, for example, identifiers of the structure, of components depicted by the respective pixel value, of locations of the components, and the like. The location of a component may, for example, be determined using a VPS of the UAV and pose information of the UAV (e.g., indicating a pose the UAV took while capturing an image of the component). In some cases, the identifiers encoded in a pixel value may include an index of a UV map at which the pixel value corresponds. Obtaining the 3D graphical representation of the structure may include importing the 3D graphical representation as a 3D model (e.g., from a CAD file) or generating the 3D graphical representation based on the images captured using the UAV. For example, generating the 3D graphical representation can include generating same using a ray-based optimization technique, such as graph clustering. Rendering the 3D graphical representation includes rendering the 3D graphical representation using shaders to visually distinguish each component of the structure and can include generating the UV map of the structure according to shaders used with the components of the structure and rendering the 3D graphical representation based on the UV map. In some cases, rendering the 3D graphical representation can include rendering different surfaces of a component of the structure within the 3D graphical representation using different ones of the shaders. For example, top and bottom surfaces of a single component may be separately rendered using different colors as the different shaders.

At 1006, the pixel values of the images are segmented into polygons according to the encoded identifiers of those pixel values. Segmenting the pixel values of the images into the polygons according to the encoded identifiers of those pixel values can include performing a computer vision process (e.g., panoptic segmentation) against the images to segment the pixel values into vector annotations corresponding to the polygons. The polygons correspond to ones of the components of the structure and thus the 3D graphical representation of the structure is segmented to separately identify the components.

At 1008, data indicative of the polygons is stored. For example, the data indicative of the polygons may include the UV map, the encoded identifiers of the pixel values, and/or other data that identifies respective ones of the shaders used for respective components of the structure. The data indicative of the polygons is stored in a data store, such as a server-side data store accessible by multiple UAVs and/or communicating devices. The data indicative of the polygons is stored for one or more purposes, including, for example, for use in a further inspection of the structure.

At 1010, the data indicative of the polygons is used to indicate images which include structure based on a query. For example, a query for images which depict the structure may be received from the UAV, the user device in communication with the UAV, or another UAV, user device, or computing device. The query is processed to generate a query response that indicates the images which depict the structure.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices.

Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining images captured during an unmanned aerial vehicle-based exploration inspection of a structure;
encoding, in each pixel value that corresponds to the structure within the images, identifiers of the structure, a component of the structure depicted using the pixel value, and a location of the component;
segmenting pixel values of the images into polygons according to the encoded identifiers; and
storing data indicative of the polygons for use in a further inspection of the structure.

2. The method of claim 1, comprising:
obtaining a three-dimensional graphical representation of the structure; and
rendering, according to the encoded identifiers, the three-dimensional graphical representation of the structure using shaders that visually distinguish each component of the structure, wherein the data indicative of the polygons identifies respective ones of the shaders.

3. The method of claim 2, wherein obtaining the three-dimensional graphical representation of the one or more structures comprises:
generating the three-dimensional graphical representation based on the images using a ray-based optimization technique.

4. The method of claim 2, wherein rendering the three-dimensional graphical representation of the structure using the shaders for each component of the structure according to the encoded identifiers comprises:
generating a UV map of the structure according to the shaders; and
rendering the three-dimensional graphical representation of the structure based on the UV map.

5. The method of claim 4, wherein each pixel value is represented by coordinates of the UV map.

6. The method of claim 2, wherein rendering the three-dimensional graphical representation of the structure using the shaders for each component of the structure according to the encoded identifiers comprises:
rendering different surfaces of a component of the structure within the three-dimensional graphical representation using different ones of the shaders.

7. The method of claim 1, wherein segmenting the pixel values of the images into the polygons according to the encoded identifiers comprises:
performing a panoptic segmentation process against the images to segment the pixel values into vector annotations corresponding to the polygons.

8. The method of claim 1, comprising:
for each component of the structure, determining a location of the component using a visual positioning system of the unmanned aerial vehicle and pose information of the unmanned aerial vehicle.

9. The method of claim 1, comprising:
obtaining a query for images depicting the structure of one or more structures; and
using the stored data to indicate the images in response to the query.

10. An unmanned aerial vehicle, comprising:
one or more cameras;
one or more memories; and
one or more processors configured to execute instructions stored in the one or more memories to:
capture images of a structure using the one or more cameras;
render a three-dimensional graphical representation of the structure with shaders visually distinguishing components of the structure by encoding, in each pixel value that corresponds to the structure within the images, identifiers of the structure, a component of the structure depicted using the pixel value, and a location of the component; and
storing data indicative of polygons associated with pixel values of the images for use in a further inspection of the structure.

11. The unmanned aerial vehicle of claim 10, wherein the one or more processors are configured to execute the instructions to:
segment the pixel values of the images into the polygons according to the encoded identifiers.

12. The unmanned aerial vehicle of claim 11, wherein, to segment the pixel values of the images into the polygons according to the encoded identifiers, the one or more processors are configured to execute the instructions to:
perform a panoptic segmentation process against the images to segment the pixel values into vector annotations corresponding to the polygons.

13. The unmanned aerial vehicle of claim 10, wherein, to render the three-dimensional graphical representation of the structure with the shaders, the one or more processors are configured to execute the instructions to:
generate a UV map of the structure according to the shaders; and
render the three-dimensional graphical representation of the structure based on the UV map.

14. The unmanned aerial vehicle of claim 13, wherein, to render the three-dimensional graphical representation of the structure with the shaders, the one or more processors are configured to execute the instructions to:
associate the pixel value with coordinates of the UV map of the structure.

15. A system, comprising:
an unmanned aerial vehicle; and
a user device in communication with the unmanned aerial vehicle,
wherein the unmanned aerial vehicle is configured to:
render a three-dimensional graphical representation of a structure with shaders visually distinguishing components of the structure by encoding, in each pixel value that corresponds to the structure within images captured of the structure, identifiers of the structure, a component of the structure depicted using the pixel value, and a location of the component; and
cause an output of data associated with the rendered three-dimensional graphical representation of the structure at the user device.

16. The system of claim 15, wherein the unmanned aerial vehicle is configured to:
capture the images; and
obtain the three-dimensional graphical representation of the structure.

17. The system of claim 16, wherein, to obtain the three-dimensional graphical representation of the structure, the unmanned aerial vehicle is configured to:
generate the three-dimensional graphical representation based on the images using graph clustering.

18. The system of claim 15, wherein the unmanned aerial vehicle is configured to:
segment pixel values of the images into polygons according to the encoded identifiers; and
store data indicative of the polygons for use in a further inspection of the structure.

19. The system of claim 18, wherein, to segment the pixel values of the images into the polygons according to the encoded identifiers, the unmanned aerial vehicle is configured to:
perform a panoptic segmentation process against the images to segment the pixel values into vector annotations corresponding to the polygons.

20. The system of claim 18, wherein the data indicative of the polygons identifies respective ones of the shaders.
